(19) United States
(12) Patent Application Publication
(10) Pub. No.: US 2019/0242983 A1
(43) Pub. Date: Aug. 8, 2019

(54) TARGET OBJECT DETECTION DEVICE

(71) Applicants: Motomu Yokota, Aichi (JP); Masao Komaya, Aichi (JP); Hoshibumi Ichiyanagi, Aichi (JP)

(72) Inventors: Motomu Yokota, Aichi (JP); Masao Komaya, Aichi (JP); Hoshibumi Ichiyanagi, Aichi (JP)

(73) Assignee: OMRON AUTOMOTIVE ELECTRONICS CO., LTD., Aichi (JP)

(21) Appl. No.: 16/268,081

(22) Filed: Feb. 5, 2019

(30) Foreign Application Priority Data
Feb. 6, 2018 (JP) 2018-018796

(51) Int. Cl. G01S 7/486; G01S 7/481; G01S 7/48; G01S 17/93

(52) U.S. Cl. CPC G01S 7/4861; G01S 17/936; G01S 7/4802; G01S 7/4817

(57) ABSTRACT

A target object detection device includes: a projection unit; a light receiving unit; an object detection unit; a distance measurement unit; and a region setting unit that sets a short distance detection region and a long distance detection region. The object detection unit detects a change state of a path based on a result of measurement performed by the distance measurement unit. The region setting unit sets the short distance detection region and the long distance detection region based on the change state of the path detected by the object detection unit. A projection distance of the measurement light is longer, a spread angle of the measurement light is smaller, and a detection sensitivity of the target object is higher in the long distance detection region than those in the short distance detection region.

### CROSS-REFERENCES TO RELATED APPLICATIONS

This application is based upon and claims the benefit of priority from Japanese Patent Application No. 2018-018796, filed on Feb. 6, 2018, the entire contents of which are incorporated herein by reference.

### FIELD

One or more embodiments of the present invention relate to a target object detection device to be mounted on a moving body and detects a target object and measures a distance to the target object by projecting and receiving light to a moving direction of the moving body.

### BACKGROUND

In order for collision prevention or a travel control, a target object detection device such as laser radar is mounted on some vehicles which are the moving body. The target object detection device detects, for example, a preceding vehicle, a person, a road, other objects, and the like being present in the moving direction of the vehicle as a target object, and measures a distance to the target object.

The target object detection device includes a radio type one and an optical type one. Among them, the optical type target object detection device includes a projection unit for projecting light and a light receiving unit for receiving the light. In the projection unit, a light emitting element such as a laser diode or the like is provided. In the light receiving unit, a light receiving element such as a photodiode or an avalanche photodiode is provided.

The measurement light projected from the projection unit is projected onto a predetermined range including the moving direction (forward direction and the like) of the vehicle. When the measurement light is reflected from the target object in the predetermined range, the reflection light is received by the light receiving unit. The presence or absence and a position of the target object are detected based on a light reception signal output from the light receiving unit according to a light receiving state. In addition, the distance to the target object is measured based on a time of flight from a time when the measurement light is projected by the projection unit until a time when the reflection light is received by the light receiving unit (so called a time of flight (TOF) method).

There is a target object detection device including a rotary scanning unit that scans the measurement light or the reflection light in the horizontal direction or in the vertical direction in order to project and receive the light over a wide area and to downsize the target object detection device (refer to JP-A-2015-143979). The rotary scanning unit includes a rotatable mirror and is also called an optical deflector or an optical scanner. As the mirror of the rotary scanning unit rotates, the measurement light projected from the projection unit is reflected from the mirror and is scanned onto a predetermined range. The reflection light reflected from the target object in the predetermined range is reflected from the mirror of the rotary scanning unit and guided to the light receiving unit. In a certain target object detection device, the reflection light from the target object is received by the light receiving unit without going through the rotary scanning unit.

In addition, for example, as disclosed in JP-A-2015-143979, there is a system that recognizes a target object in front of the vehicle by a cooperation of the target object detection device and an image processing device. In JP-A-2015-143979, the predetermined range in front of the vehicle is imaged by a camera, and then, the distance to the target object in the predetermined range is measured by the laser radar. Then, a road surface of the road on which the vehicle is traveling, a gradient of the road surface, and a road surface region in the captured image are detected from a result of image processing of the image captured by the camera or a result of measuring the distance performed by the laser radar. Furthermore, an object candidate region is set based on the road surface region in the captured image, and the presence or absence of the target object such as a preceding vehicle in the object candidate region is monitored.

If facing a predetermined range in which the target object is detected from the target object detection device side (vehicle side), the target object looks larger as it comes closer and looks smaller as it leaves away. For the target object at the short distance, it is required to capture almost the entire target object in order to recognize the position, size and shape of the target object. In addition, for the target object such as the target object at the long distance or the oncoming vehicle, it is required to increase a detection sensitivity (ease of capturing the target object) in order to accurately detect the target object.

Therefore, for example, in a target object detection device disclosed in Japanese Patent NO. 3330624, a short distance detection region for detecting the target object at the short distance from the vehicle and a long distance detection region for detecting the target object at the long distance from the vehicle are set in the predetermined range in front of the vehicle. In the short distance detection region, the projection distance of the measurement light is short, and the horizontal spread angle of the measurement light is large. On the other hand, in the long distance detection region, the projection distance of the measurement light is long and the horizontal spread angle of the measurement light is small. The size of the short distance detection region and the long distance detection region (the horizontal spread angle of the measurement light) is changed based on a vehicle speed of the vehicle, an operation state of the wiper, a lighting state of the light, an operating state of the blinker, and the like.

In addition, in a target object detection device disclosed in JP-A-7-167958, a plurality of light emitting elements are provided in the projection unit, the light emitting operation of each light emitting element is controlled based on a reception intensity of reflection light from a plurality of angular directions in a horizontal plane, a vehicle speed, a rotation angle of the steering wheel, and then, the power of measurement light (light amount, light intensity, spread angle of light, and the light) to the plurality of angular directions in the horizontal plane are individually changed. If the vehicle is traveling on a straight road, a projection distance is increased by increasing the power of measurement light to the angular direction near the host vehicle center line, and the projection distance is decreased by decreasing the power of measurement light to the angular direction of both outer sides away from the host vehicle center line. In addition, if the vehicle is traveling on a curved road, the projection distance is increased by increasing the power of measurement light to the angular direction inside the curve with respect to the host vehicle center line, and the projection distance is decreased by decreasing the power of measurement light to the angular direction outside of the curve.

### SUMMARY

If it is assumed that the path (road or the like) for the moving body such as a vehicle is flat and has a straight moving direction, and the short distance detection region and the long distance detection region are set in the predetermined range including the moving direction, when there occurs changes such as a gradient or a curve on the path, there is a problem in that the target object at the long distance in the long distance detection region cannot be captured, and thus, the distance to the target object may not be measured.

An object of one or more embodiments of the invention is to provide a target object detection device to be mounted on a moving body that can accurately detect the target object at the short distance and the target object at the long distance, and accurately detect the target object at the long distance even if there occurs a change in the state of the path for the moving body.

One or more embodiments of the invention provide a target object detection device to be mounted on a moving body, the target object detection device including: a projection unit that projects measurement light to a predetermined range including a moving direction of the moving body; a light receiving unit that receives reflection light of the measurement light reflected from a target object in the predetermined range, and outputs a light reception signal corresponding to a light receiving state; an object detection unit that detects the target object based on the light reception signal; a distance measurement unit that measures a distance to the target object based on a time of flight from a time when the measurement light is projected by the projection unit to a time when the reflection light is received by the light receiving unit; and a region setting unit that sets a short distance detection region for detecting the target object at a short distance shorter than a predetermined distance and a long distance detection region for detecting the target object at a long distance equal to or longer than the predetermined distance, in the predetermined range. The object detection unit detects a change state of a path through which the moving body passes based on a result of measurement performed by the distance measurement unit, and the region setting unit sets the short distance detection region and the long distance detection region based on the change state of the path detected by the object detection unit. A projection distance of the measurement light is longer, a spread angle of the measurement light is smaller, and a detection sensitivity of the target object is higher in the long distance detection region than those in the short distance detection region.

According to the above description, the change state of the path of the moving body is detected by the object detection unit based on the result of measurement of the distance to the target object performed by the distance measurement unit, and the short distance detection region and the long distance detection region are set by the region setting unit within the predetermined range from which the target object is detected based on the change state of the path. In the long distance detection region, the projection distance of the measurement light is longer and the spread angle of the measurement light is smaller than those in the short distance detection region, and thus, the detection sensitivity of the target object is higher. Therefore, in the short distance detection region where the spread angle of the measurement light is large, the target object at the short distance can be captured and thus, it is possible to detect the target object with high accuracy. In addition, in the long distance detection region where the projection distance of the measurement light is long, the target object at the long distance can be captured, and thus, it is possible to detect the target object with high accuracy. Furthermore, even if there is a change in the state of the path of the moving body in the moving direction, it is possible to accurately detect the target object at the long distance in the long distance detection region.

In one or more embodiments of the invention, the projection unit may project the measurement light in a plurality of directions in the predetermined range, the light receiving unit may receive the reflection light from the plurality of directions and outputs the light reception signal based on the reflection light from each of the plurality of directions, the distance measurement unit may measure the distance to the target object in each of the plurality of directions, and the object detection unit may determine a distance to the path based on the distance to the target object in each of the plurality of directions measured by the distance measurement unit, and may detect the change state of the path based on the distance to the path.

In addition, in one or more embodiments of the invention, the distance measurement unit may measure the distance to the target object in a unit of section which is a result of dividing the predetermined range seen from the target object detection device side into a plurality of sections, the object detection unit may detect the path and the change state of the path based on a distribution of the measurement distance of each of the plurality of sections measured by the distance measurement unit, and the region setting unit may set the short distance detection region and the long distance detection region in the unit of section.

In addition, in one or more embodiments of the invention, the target object detection device may further include a rotary scanning unit that includes a mirror, and by rotating the mirror, causes the measurement light projected from the projection unit to be reflected from the mirror and be scanned to the predetermined range, or causes the reflection light from the target object to be reflected from the mirror and be guided to the light receiving unit, and a rotation measurement unit that measures a rotation angle of the mirror. The light receiving unit may include a plurality of light receiving elements that receive the reflection light from the plurality of directions and output the light reception signal corresponding to the light receiving state, and the distance measurement unit may measure a distance to the target object in the unit of section based on the rotation angle of the mirror, a projection state of the projection unit, the light receiving state of each of the plurality of light receiving elements, and the time of flight.

In addition, in one or more embodiments of the invention, the plurality of light receiving elements may be arranged in a vertical direction, the projection unit may include a plurality of light emitting elements arranged in the vertical direction and sequentially emitting light according to the rotation angle of the mirror, the rotary scanning unit may horizontally scan the measurement light and the reflection light, the distance measurement unit may measure the distance to the target object in the unit of section which is a result of dividing the predetermined range into the plurality of sections having a grid shape, based on the rotation angle of the mirror, a light emitting state of each of the plurality of light emitting elements, the light receiving state of each of the plurality of light receiving elements, and the time of flight.

In addition, in one or more embodiments of the invention, the target object detection device may further include a control unit that controls the operations of the projection unit, the light receiving unit, and the rotary scanning unit. The control unit may form the short distance detection region and the long distance detection region within the predetermined range and adjust positions of both of the short distance detection region and the long distance detection region by controlling a light emitting operation performed by the light emitting element corresponding to each of the plurality of sections, a light receiving operation performed by the light receiving element corresponding to each of the plurality of sections, or a signal processing operation performed by the light receiving unit for the light reception signal output from the light receiving element.

In addition, in one or more embodiments of the invention, the region setting unit may set the long distance detection region such that a forward portion of the path is configured to be captured, and may set the short distance detection region around the long distance detection region.

Furthermore, in one or more embodiments of the invention, the object detection unit may detect a gradient of the path as the change state of the path, and the region setting unit may adjust positions of the short distance detection region and the long distance detection region in vertical direction according to the gradient of the path detected by the object detection unit.

According to one or more embodiments of the invention, in the target object detection device mounted on the moving body, it is possible to accurately detect the target object at the short distance and the target object at the long distance, and it is possible to accurately detect the target object at the long distance even if there occurs a change in the state of the path for the moving body.

### BRIEF DESCRIPTION OF DRAWINGS

FIG. 1 is a plan view of an optical system of a target object detection device according to an embodiment of the invention;

FIG. 2 is a rear view of the optical system of the target object detection device in FIG. 1;

FIG. 3 is a diagram illustrating a projection state of the target object detection device in FIG. 1;

FIG. 4 is a diagram illustrating an arrangement of LDs and PDs in FIG. 1;

FIG. 5 is a diagram illustrating an electrical configuration of the target object detection device in FIG. 1;

FIG. 6 is a diagram illustrating an example of light projection and light receiving timing of the LDs and the PDs in FIG. 4;

FIG. 7A and FIG. 7B are diagrams illustrating examples of results of measuring the distance performed by the target object detection device in FIG. 1 when the road is flat;

FIG. 8A and FIG. 8B are diagrams illustrating examples of results of measuring the distance performed by the target object detection device in FIG. 1 when the road has an upward gradient;

FIG. 9A and FIG. 9B are diagrams illustrating examples of results of measuring the distance performed by the target object detection device in FIG. 1 when the road has a downward gradient;

FIG. 10A to FIG. 10C are diagrams illustrating projection states to the road by the target object detection device in FIG. 1;

FIG. 11 is a diagram illustrating an example of a detection region of the target object detection device in FIG. 1 when the road is flat;

FIG. 12A and FIG. 12B are diagrams illustrating examples of a detection region of a target object detection device in FIG. 1 when the road has an upward gradient;

FIG. 13A and FIG. 13B are diagrams illustrating examples of the detection region of the target object detection device of FIG. 1 when the road has a downward gradient;

FIG. 14 is a flowchart illustrating an operation of the target object detection device in FIG. 1; and

FIG. 15A and FIG. 15B are diagrams illustrating examples of result of measuring the distance performed by the target object detection device according to another embodiment.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, one or more embodiments of the invention will be described with reference to the drawings. In each drawing, the same reference numerals will be given to the same or corresponding parts.

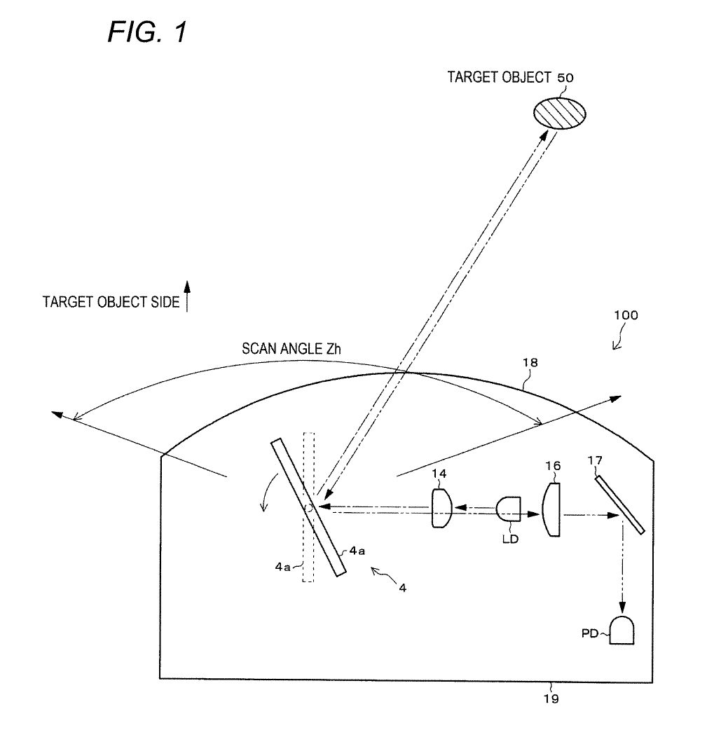

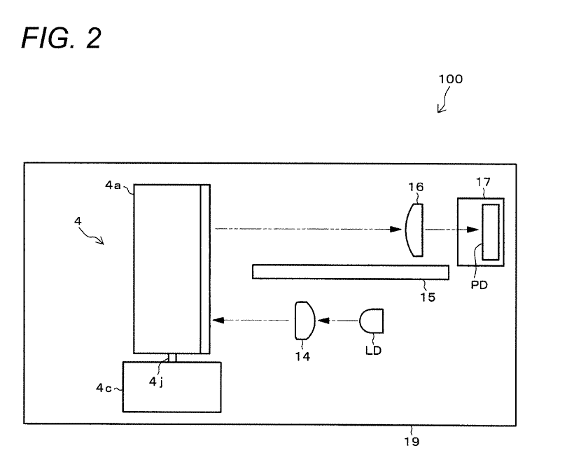

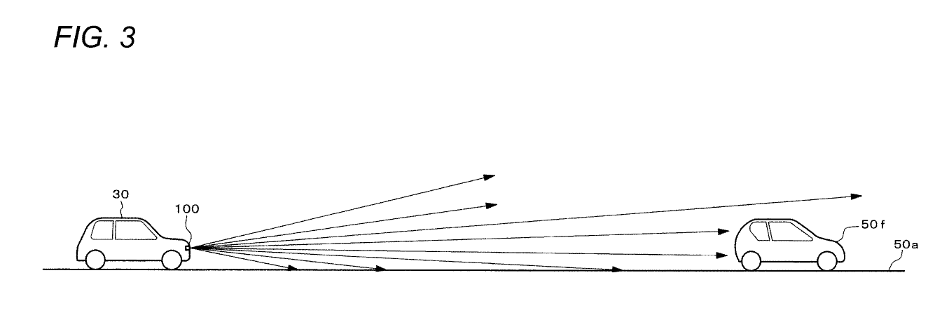

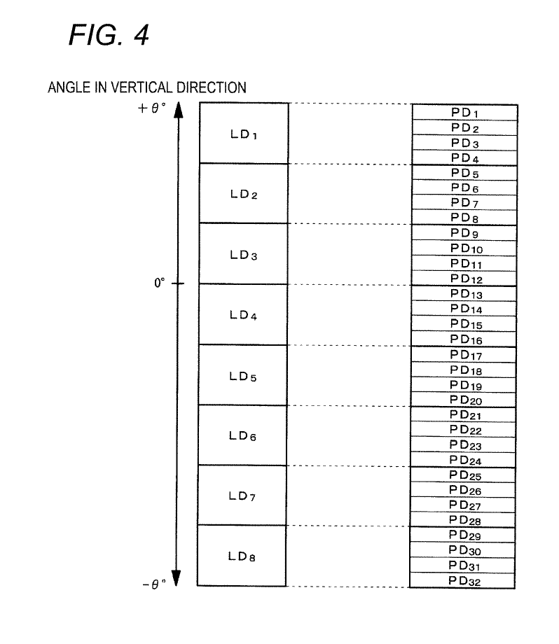

FIG. 1 is a plan view of an optical system of a target object detection device 100 according to an embodiment seen from top. FIG. 2 is a rear view of the optical system of the target object detection device 100 seen from the rear side (the lower side in FIG. 1, that is, the side opposite to the target object 50). FIG. 3 is a view illustrating a projection state of the target object detection device 100, and illustrates a state seen from the side of the vehicle 30. FIG. 4 is a diagram illustrating an arrangement of LD and PD in FIG. 1.

The target object detection device 100 is configured with optical laser radar mounted on a vehicle 30 configured as a four-wheeled automobile as illustrated in FIG. 3, for example. The vehicle 30 is an example of a “moving body” in one or more embodiments of the invention. The target object 50 detected by the target object detection device 100 are another vehicle, persons, road (road surface), or other objects.

As illustrated in FIG. 1 and FIG. 2, the target object detection device 100 includes an optical system configured with a laser diode (LD), a projection lens 14, a rotary scanning unit 4, a light receiving lens 16, a reflection mirror 17, and a photo diode (PD). Among them, the LD, the projection lens 14, and the rotary scanning unit 4 configures a projection optical system. In addition, the rotary scanning unit 4, the light receiving lens 16, the reflection mirror 17, and the PD configure a light receiving optical system.

These optical systems are accommodated in a case 19 of the target object detection device 100. A transmission window 18 is provided on the front surface (the side of the target object 50) of the case 19. The transmission window 18 is configured with a rectangular window frame and a light-transmitting plate material fitted in the window frame (not illustrated in detail).

In the present example, the target object detection device 100 is installed at a predetermined position at the front of the vehicle 30 such that the transmission window 18 faces the moving direction of the vehicle 30. Specifically, the target object detection device 100 is installed at the front of the vehicle 30, at the center in the vehicle width direction and at a predetermined height from a road 50a (FIG. 3) where the vehicle 30 travels.

The LD is a light emitting element that projects high power laser light (light pulse). In FIG. 1 and FIG. 2, for the sake of convenience, only one LD is illustrated, but as illustrated in FIG. 4, a plurality of LDs are arranged in the vertical direction (LD₁ to LD₈). Each LD is arranged in such a manner that the light emitting surface faces the mirror 4a (FIG. 1, and the like) side of the rotary scanning unit 4.

The PD is a light receiving element that receives the reflection light of the measurement light projected from the LD reflected from the target object 50. In FIG. 1 and FIG. 2, for the sake of convenience, only one PD is illustrated, but as illustrated in FIG. 4, a plurality of PDs are provided in the vertical direction (PD₁ to PD₃₂). Each PD is arranged in such a manner that the light receiving surface faces the reflection mirror 17 (FIG. 1, and the like) side.

The rotary scanning unit 4 is also called as a rotating mirror, an optical scanner, or an optical deflector. The rotary scanning unit 4 includes a mirror 4a, a motor 4c, and the like. The mirror 4a is formed in a plate shape. The front surface and the rear surface of the mirror 4a are reflective surfaces.

As illustrated in FIG. 2, a motor 4c is provided below the mirror 4a. A rotation shaft 4j of the motor 4c is parallel to the vertical direction (up-down direction). A connection shaft (not illustrated) located at the center of the mirror 4a is fixed to the upper end of the rotation shaft 4j of the motor 4c. In conjunction with the rotation shaft 4j of the motor 4c, the mirror 4a rotates.

In the case 19, the light receiving lens 16, the reflection mirror 17, and the PD are arranged around the upper part of the mirror 4a of the rotary scanning unit 4. The LD and the projection lens 14 are arranged around the lower part of the mirror 4a. A light shielding plate 15 is provided above the LD and the projection lens 14 and below the light receiving lens 16. The light shielding plate 15 is fixed in the case 19, and separates the projection path and the light receiving path from each other.

The light projection and receiving paths for detecting the target object 50 are as indicated by a dash-dotted arrow and a two-dot chain arrow in FIG. 1 and FIG. 2. Specifically, as illustrated by the dash-dotted arrow in FIG. 1 and FIG. 2, the laser light projected from the LD arrives at the lower half region of the front or back surface of the mirror 4a of the rotary scanning unit 4 after the spreading is adjusted by the projection lens 14. At this time, the motor 4c rotates and the angle (direction) of the mirror 4a changes, and then, the angle of the front or back surface of the mirror 4a becomes a predetermined angle that faces the target object 50 side (for example, the state of the mirror 4a indicated by the solid line in FIG. 1). As a result, the laser light from the LD is reflected from the lower half region of the front or back surface of the mirror 4a after passing through the projection lens 14, and then, is transmitted through the transmission window 18 and scanned to a predetermined range outside the case 19. That is, the rotary scanning unit 4 deflects the laser light from the LD to the predetermined range.

The scan angle Zh illustrated in FIG. 1 indicates a range of angle of the laser light projected from the target object detection device 100 in the horizontal direction after being projected from the LD and reflected from the front or back surface of the mirror 4a of the rotary scanning unit 4.

In addition, as illustrated in FIG. 4, since a plurality of LDs are arranged in the vertical direction, each LD projects the laser light to a plurality of different angular directions in the vertical plane. “0°” between the LD₃ and the LD₄ means the horizontal direction. LD₁ to LD₃ project the laser light upward (positive angular direction) with respect to the horizontal direction. In addition, the LD₃ also projects the laser light in the horizontal direction. The LD₄ to LD₈ project the laser light downward (negative angular direction) with respect to the horizontal direction. In addition, the LD₄ also projects the laser light in the horizontal direction. Therefore, for example, as illustrated in FIG. 3, laser light is projected from the target object detection device 100 toward the front of the vehicle 30, the laser light projected downward with respect to the horizontal direction arrives at the road 50a on which the vehicle 30 travels. The laser light also arrives at the target object 50 such as the preceding vehicle 50f that exists in front of the vehicle 30.

The laser light projected to the predetermined range from the target object detection device 100 is reflected from the target object 50 in the predetermined range. As indicated by the two-dot chain arrows in FIG. 1 and FIG. 2, the reflection light transmits through the transmission window 18 and arrives at the upper half region of the front or back surface of the mirror 4a. At this time, the motor 4c rotates and the angle (direction) of the mirror 4a changes, and thus, the front or back surface of the mirror 4a makes a predetermined angle facing the target object 50 side (for example, the state of the mirror 4a indicated by the solid line in FIG. 1). As a result, the reflection light from the target object 50 is reflected from the upper half region of the front or back surface of the mirror 4a and is incident on the light receiving lens 16. In other words, the rotary scanning unit 4 deflects the reflection light from the target object 50 toward the light receiving lens 16. Then, the reflection light is collected by the light receiving lens 16, reflected from the reflection mirror 17, and received by the PD. That is, the rotary scanning unit 4 guides the reflection light from the target object 50 to the PD via the light receiving lens 16 and the reflection mirror 17.

As illustrated in FIG. 4, four PDs correspond to one LD. Specifically, PD₁ to PD₄ correspond to LD₁, PD₅ to PD₈ correspond to LD₂, PD₉ to PD₁₂ correspond to LD₃, PD₁₃ to PD₁₆ correspond to LD₄, PD₁₇ to PD₂₀ correspond to LD₅, PD₂₁ to PD₂₄ correspond to LD₆, PD₂₅ to PD₂₈ correspond to LD₇, and PD₂₉ to PD₃₂ correspond to LD₈. Therefore, the reflection light of the laser light projected from each LD is reflected from the target object 50 is received by each corresponding PD. That is, each PD receives the reflection light from a plurality of different directions.

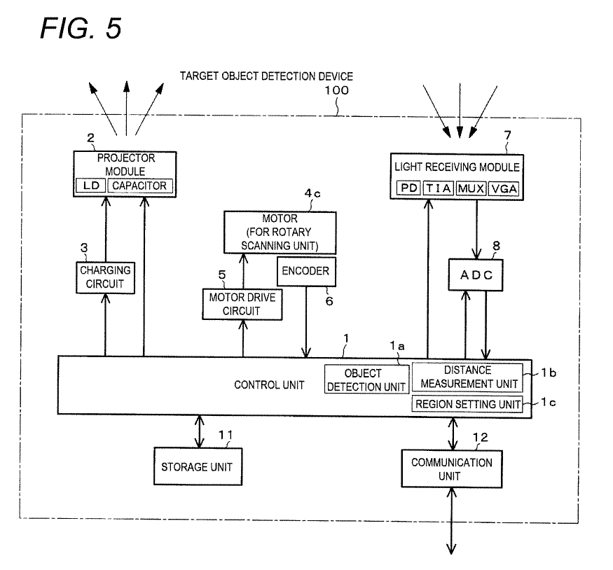

FIG. 5 is a diagram illustrating an electrical configuration of the target object detection device 100. The target object detection device 100 includes a control unit 1, a projector module 2, a charging circuit 3, a motor 4c, a motor drive circuit 5, an encoder 6, a light receiving module 7, an analog to digital converter (ADC) 8, a storage unit 11, and a communication unit 12.

The control unit 1 is configured with a microcomputer or the like, and controls operations of each part of the target object detection device 100. The control unit 1 is provided with an object detection unit 1a, a distance measurement unit 1b, and a region setting unit 1c.

The storage unit 11 is configured with a volatile or nonvolatile memory. The storage unit 11 stores information for the control unit 1 to control each part of the target object detection device 100, and information for detecting the presence or absence of the target object 50 and for measuring the distance to the target object 50, and the like.

The communication unit 12 is configured with a circuit for communicating with another vehicle-mounted device such as an electronic control unit (ECU) (not illustrated).

For example, the control unit 1 transmits the result of detecting the target object 50 to the other vehicle-mounted device using the communication unit 12. In addition, the control unit 1 acquires the information on the vehicle state and the like using the communication unit 12 communicating with other vehicle-mounted devices.

The projector module 2 is provided with a plurality of LDs described above and a capacitors for causing each LD to emit the light. In FIG. 5, the LD and capacitor block is respectively illustrated in one for the sake of convenience. The projector module 2 is an example of the “projection unit” in one or more embodiments of the invention.

The charging circuit 3 charges the capacitors in the projector module 2. In FIG. 5, only one block of the charging circuit 3 is illustrated, however, a plurality of charging circuits 3 may be provided according to the number of installed LDs and capacitors. The control unit 1 controls light emitting operation of the LDs and the charging operation of the charging circuits 3 in the projector module 2. Specifically, the control unit 1 causes each LD to emit the light and to project the laser light. In addition, the control unit 1 stops the light emission of each LD and charges the capacitor using the charging circuit 3.

The motor 4c is a driving source for rotating the mirror 4a in the rotary scanning unit 4. The control unit 1 controls the driving of the motor 4c using the motor drive circuit 5 to rotate the mirror 4a. The encoder 6 outputs a signal corresponding to the rotation state of the motor 4c. The control unit 1 detects the rotation state (the rotation angle, the rotation speed, and the like) of the motor 4c and the mirror 4a based on the output of the encoder 6. The encoder 6 is an example of a “rotation measurement unit” in one or more embodiments of the invention.

The control unit 1 causes the motor 4c to rotate the mirror 4a, and to scan the laser light projected from the LD on the predetermined range, and then, guides the reflection light reflected from the target object 50 in the predetermined range to the PDs in the light receiving module 7.

The light receiving module 7 includes a plurality of PDs, a transimpedance amplifier (TIA), a multiplexer (MUX), and a variable gain amplifier (VGA). The light receiving module 7 is an example of the “light receiving unit” in one or more embodiments of the invention.

A plurality of TIAs are provided corresponding to a plurality of PDs. In FIG. 5, only one PD and TIA are indicated by one block for the sake of convenience. Each PD by receives the light and outputs a current (light reception signal) corresponding to the light receiving state. Each TIA converts the current flowing through the corresponding PD into a voltage signal and outputs the signal to the MUX.

The MUX selects the output signal of each TIA and outputs the selected signal to the VGA. The VGA amplifies the signal output from the MUX and outputs the result to the ADC 8. The ADC 8 converts an analog signal output from the VGA to a digital signal at a high speed and outputs the result to the control unit 1. In this way, the signal processing for the light reception signal corresponding to the light receiving state of each PD in the light receiving module 7 is performed by the TIA, the MUX, and the VGA, and then, the result is output to the control unit 1 via the ADC 8. In FIG. 5, only one block of VGA and ADC 8 is illustrated, however, a plurality of VGAs and ADCs 8 may be provided according to the number of installed PDs.

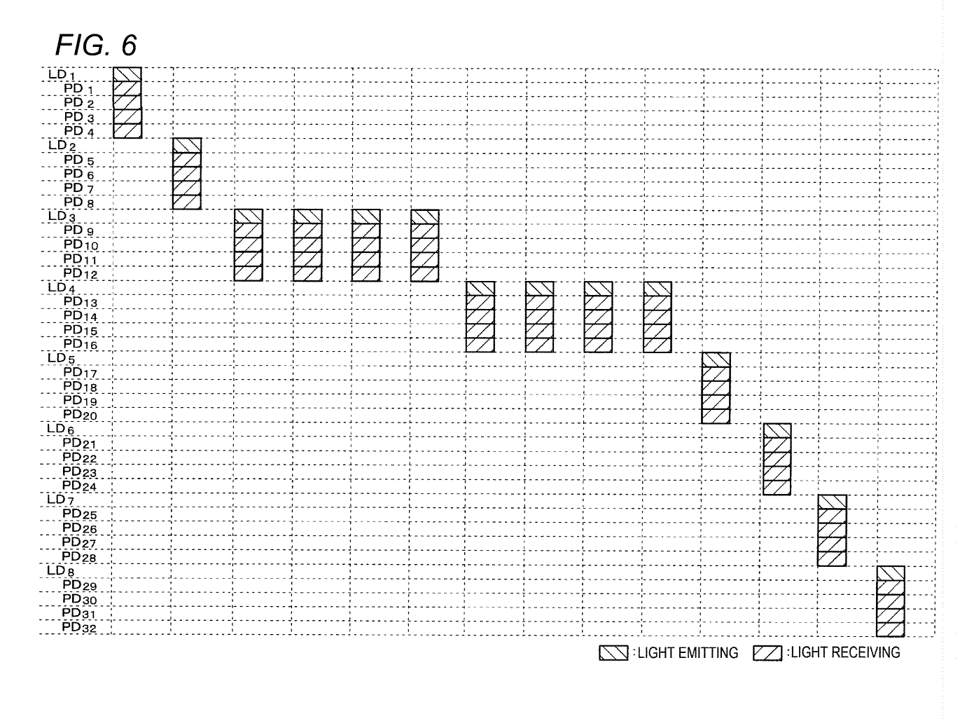

FIG. 6 is a diagram illustrating an example of the light projection and the light receiving timing of the LDs and the PDs. As illustrated in FIG. 6, the control unit 1 in FIG. 5 causes each of the LD₁ to LD₈ to sequentially emit the light and to be sequentially received by the corresponding PD₁ to PD₃₂ according to the rotation angle of the mirror 4a in the rotary scanning unit 4. The control unit 1 performs signal processing for the light reception signals output by each of the PD₁ to PD₃₂ according to the light receiving state using the TIA, MUX, VGA, and ADC 8. In addition, the control unit 1 charges the capacitor in the projector module 2 using the charging circuit 3 every time when each LD₁ to LD₈ emits the light.

The object detection unit 1a in FIG. 5 detects the rotation angle of the mirror 4a, the light receiving state (whether or not the reflection light is received from a plurality of directions) of each PD based on the light reception signal input from the light receiving module 7 via the ADC 8 according to the rotation angle of the mirror 4a, the light emitting state of each LD, and the light receiving state of each PD. In addition, the object detection unit 1a detects the presence or absence of the target object 50, the position, size, shape, or type of the existing target object 50 based on the light emitting state of each LD, the light receiving state of each PD, and the light reception signal.

The distance measurement unit 1b measures, for example, the maximum value (maximum voltage value) of the light reception signal input from the light receiving module 7 via the ADC 8, and measures the light receiving time of the reflection light from the target object 50 based on the maximum value. Then, the distance measurement unit 1b calculates the time of flight from the time when the laser light is projected from the corresponding LD to the light receiving time of the reflection light, and the distance to the target object 50 is measured based on the time of flight (so-called a time of flight (TOF) method). That is, the distance measurement unit 1b measures the distances to the target object 50 in a plurality of directions in which the laser light and the reflection light are projected and received.

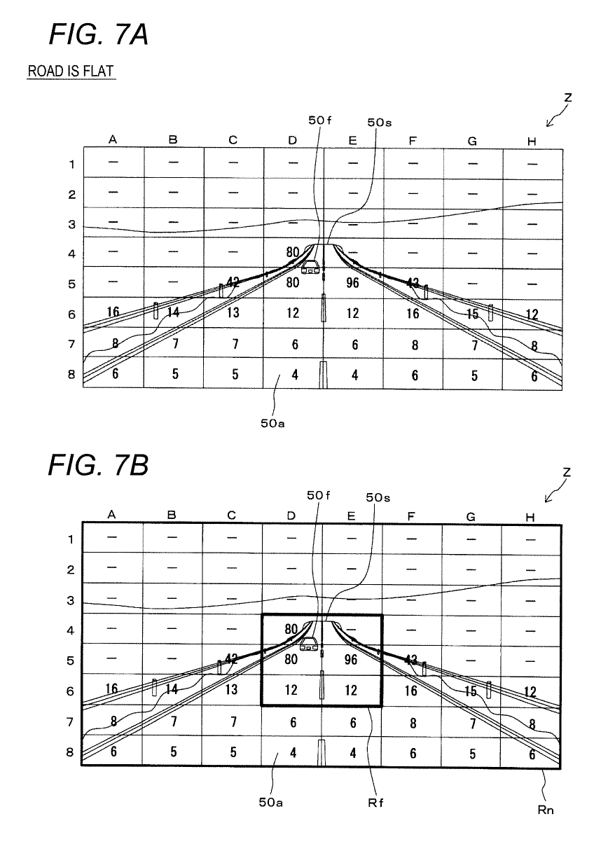

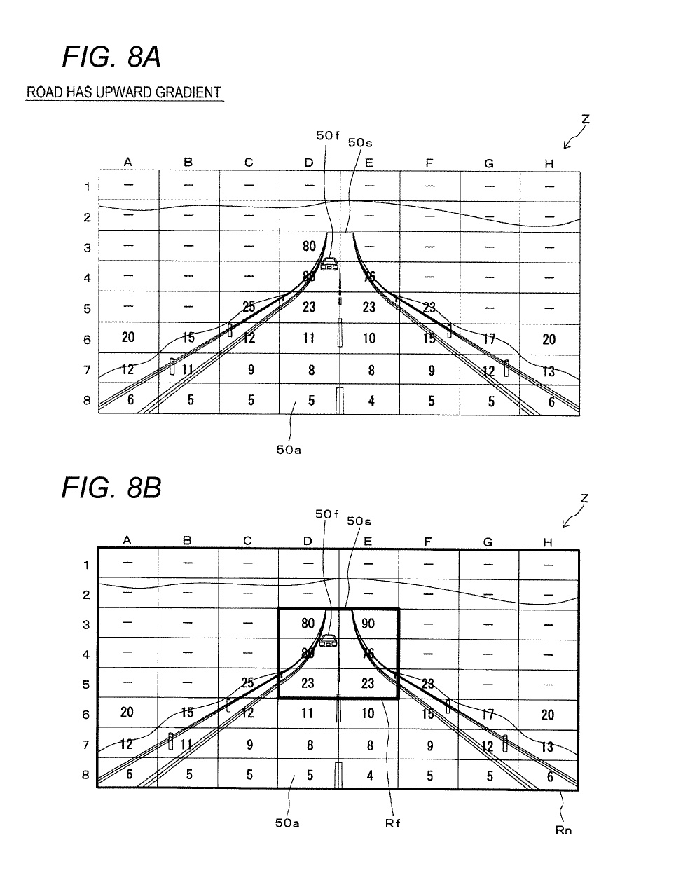

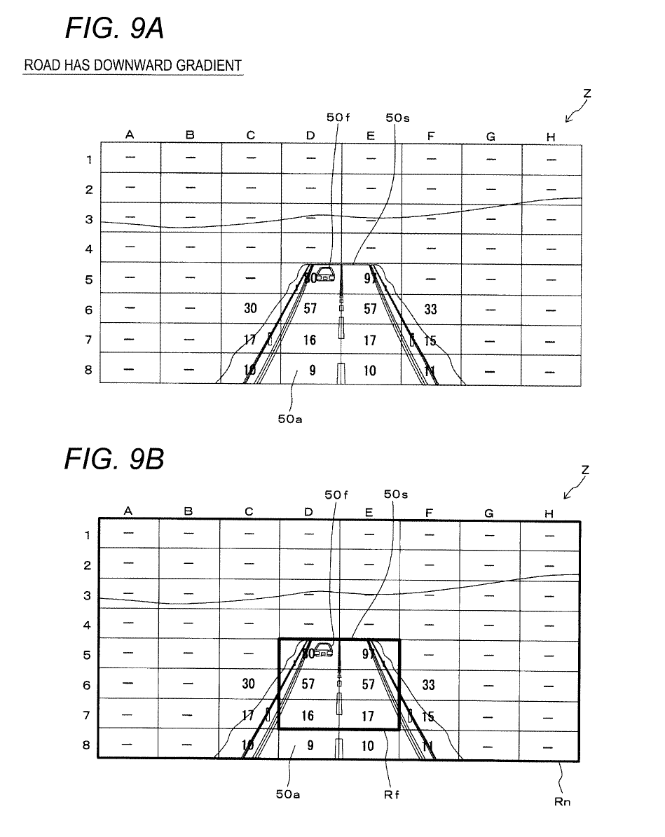

FIG. 7A to FIG. 9B are diagrams illustrating examples of the result of measuring the distance by the distance measurement unit 1b in the target object detection device 100. Specifically, FIG. 7A and FIG. 7B illustrate a case where the road 50a is flat in the forwarding (traveling) direction of the vehicle 30, FIG. 8A and FIG. 8B illustrate a case where the road 50a has an upward gradient, and FIG. 9A and FIG. 9B illustrate a case where the road 50a has a downward gradient.

In addition, in FIG. 7A to FIG. 9B, the predetermined range Z seen from the side of the target object detection device 100 is illustrated, from which the target object detection device 100 detects the target object 50. In addition, for the sake of convenience, some scenery such as the road 50a seen from the side of the target object detection device 100 is also illustrated in predetermined range Z. The predetermined range Z is divided into a plurality of grids in the form of upper, lower, left and right grids. In order to distinguish each section of predetermined range Z, signs A to H are assigned to the upper part of each column, and numbers 1 to 9 are assigned to the left part of each row. In this way, for example, the section at the top and the leftmost is marked as “section A1”.

The laser light is projected to each section of the predetermined range Z according to the rotation angle of the corresponding LD and mirror 4a. Then, the reflection light from the target object 50 in each section is received by the corresponding PD. That is, each section of the predetermined range Z corresponds to each direction in which the laser light and the reflection light are projected and received.

The distance measurement unit 1b measures the distance to the target object 50 in a unit of section in the predetermined range Z based on the rotation angle of the mirror 4a, the light emitting state of each LD, the light receiving state of each PD, and the time of flight described above. That is, the distance measurement unit 1b measures the distance to the target object 50 in each direction in which the laser light and the reflection light are projected and received. In addition, the distance measurement unit 1b records the result of measuring the distance in the storage unit 11 in association with each section.

In FIG. 7A to FIG. 9B, the numerical values of the distances (in m (meters)) measured by the distance measurement unit 1b are indicated in each section. In this example, the distance measuring unit 1b can measure the distance up to 100 m. In some sections, “-” is displayed, which means that it is not possible to measure the distance by the distance measuring unit 1b. This is because, even if the laser light is projected from the corresponding LD to the section, since the distance to the target object 50 is too far, the laser light does not arrive at the target object 50, and thus, the reflection light from the target object 50 is received by the corresponds PD.

The road 50a on which the vehicle 30 travels and a target object 50 (a person, another vehicle 50f, and other objects) other than the road 50a are present in the predetermined range Z. Therefore, the distance to each section measured by the distance measuring unit 1b is the distance to the road 50a or the distance to the target object 50 other than the road 50a.

In addition, as described above, the plurality of LDs illustrated in FIG. 4 project the laser lights to the predetermined different angular directions in the vertical plane. The plurality of PDs receive the reflection light of the laser light projected from the corresponding LD which is reflected from the target object 50, that is, the reflection light from the predetermined different angular directions in the vertical plane. The target object detection device 100 is installed in a predetermined orientation at a predetermined position (a position at a predetermined height from the road 50a and at the center in the vehicle width direction) at the front of the vehicle 30. Therefore, the LD that projects the laser light for detecting the road 50a, the PD that receives the reflection light from the road 50a, and the rotation angle of the mirror 4a for detecting the road 50a are respectively fixed.

Specifically, in the predetermined range Z in FIG. 7A to FIG. 9B, since the road 50a is captured at least in the sections of below the third row of the columns D and E at the center, those sections are the sections for road detection, the LD, the PD, the rotation angle of and mirror 4a corresponding to those sections are the LD, the PD, and the rotation angle of the mirror 4a for the road detection. In addition, depending on the change state of road 50a, since there is a high possibility that the road 50a is captured even in the sections around the sections described above, such surrounding sections are also the sections for the road detection, the LD, the PD, and the rotation angle of the mirror 4a corresponding to the surrounding sections are also the LD, the PD, and the rotation angle of the mirror 4a for the road detection. Of course, these LD, PD and the rotation angle of the mirror 4a for the road detection are used for detecting other target objects.

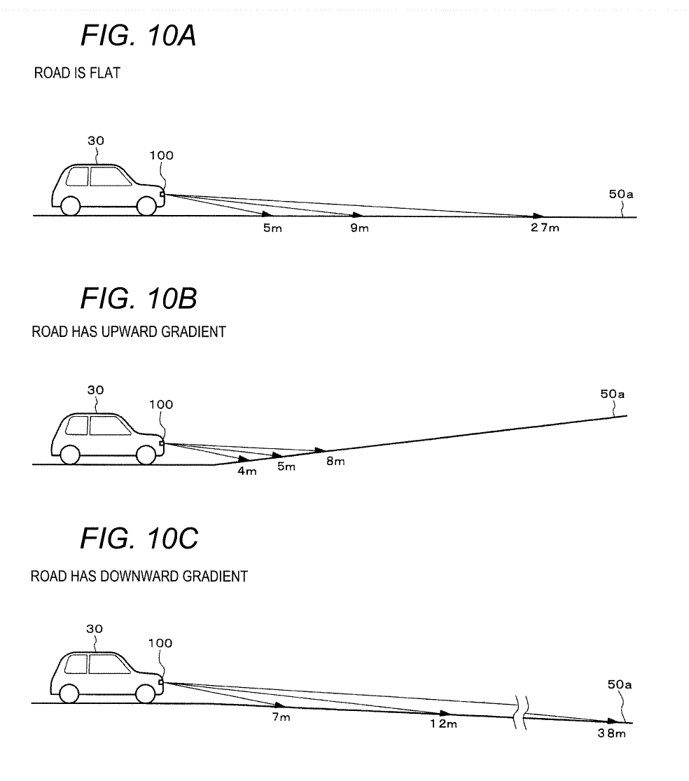

FIG. 10A to FIG. 10C are diagrams illustrating the projection states to the road 50a by the target object detection device 100, which is seen from the side of the vehicle 30. Specifically, the projection and the reflection is performed by the LD, the PD, and the rotation angle of the mirror 4a corresponding to a plurality of sections for the road detection positioned at below the third row of the column D or E in FIG. 7A to FIG. 9B, and the distance to the road 50a in each section is measured by the distance measuring unit 1b and the result of measurement is indicated in FIG. 10A to FIG. 10C.

For example, the road surface of the road 50a farther from the vehicle 30 is captured from the sections positioned at above the column E in in FIG. 7A to FIG. 9B than that from the sections positioned at below the column E. Then, the LD corresponding to the sections positioned at above the column E projects the laser light to the road surface of the road 50a farther from the vehicle 30 than the LD corresponding to the sections positioned at below the column E (FIG. 10). Therefore, the distance measured by the distance measurement unit 1b increases as the measurement goes from the section (section E8) in the bottom row of the column E to the section on the top side (FIG. 7A to FIG. 9B).

In addition, the measurement distance of the section for the road detection measured by the distance measurement unit 1b is shorter when the road 50a has the upward gradient (gradient>0) as illustrated in FIG. 10B than the measurement distance when the road 50a is flat (gradient=0) as illustrated in FIG. 10A (refer to FIG. 7A to FIG. 8B). In addition, the measurement distance of the section for the road detection measured by the distance measurement unit 1b is longer when the road 50a is flat (gradient=0) as illustrated in FIG. 10C than the measurement distance when the road 50a has the upward gradient (gradient>0) as illustrated in FIG. 10A (refer to FIG. 7A to FIG. 9B). That is, as the upward gradient of the road 50a increases, the measurement distance of the section for the road detection measured by the distance measurement unit 1b decreases, and as the downward gradient of the road 50a increases, the measurement distance of the section for the road detection measured by the distance measurement unit 1b increases.

The object detection unit 1a in FIG. 5 detects the road 50a and the change state of the road 50a based on the result of measurement performed by the distance measuring unit 1b as described above. Specifically, for example, the distance to the road 50a in each section for the road detection in a case of flat road 50a is measured in advance by the distance measuring unit 1b, and then, the result is stored in the storage unit 11 as distance data for the flat road. The distance to the road 50a in each section for the road detection in a case of the road 50a having the maximum upward gradient that the vehicle 30 can travel is measured in advance by the distance measuring unit 1b, and then, the result is stored in the storage unit 11 as distance data for the maximum upward gradient. Furthermore, the distance to the road 50a in each section for the road detection in a case of the road 50a having the maximum downward gradient that the vehicle can travel is measured in advance by the distance measuring unit 1b, and then, the result is stored in the storage unit 11 as distance data for the maximum downward gradient.

Then, the light is projected and received by the LD, the PD, and the rotary scanning unit 4, the object detection unit 1a compares the measurement distance of each section measured by the distance measuring unit 1b with the distance data for the maximum upward gradient and the distance data for the maximum downward gradient of each section stored in the storage unit 11. Here, if the measurement distance is equal to or longer than the distance data for the maximum upward gradient and equal to or shorter than the distance data for the maximum downward gradient, the object detection unit 1a determines that the road 50a is present in the corresponding section and that the measurement distance is the distance to the road 50a. In addition, if the measurement distance is not equal to or longer than the distance data for the maximum upward gradient and not equal to or shorter than the distance data for the maximum downward gradient, the object detection unit 1a determines that the road 50a is not present in the corresponding section and that the measurement distance is the distance to the target object 50 other than the road 50a.

For another example, the object detection unit 1a may detect the presence or absence of the road 50a based on the light reception signal of each direction (each section) input from the light receiving module 7 via the ADC 8. For example, the road 50a is a planar object having no sharp height compared to another target object 50. Therefore, the light reception signal output from the light receiving module 7 based on the reflection light from the road 50a has different characteristics in intensity, level, signal length, and the like compared the light reception signal output from the light receiving module 7 based on the reflection light from another target object 50. Accordingly, the object detection unit 1a may extract feature points of the light reception signal, and may determine the presence or absence of the road 50a in the unit of section basis based on the feature points. Alternatively, the object detection unit 1a may detect the presence or absence of the road 50a based on both the light reception signal and the result of measurement performed by the distance measuring unit 1b.

In addition, the object detection unit 1a detects the change state of the road 50a based on the distribution of the measurement distances of each section and the distance to the road 50a in the determined plurality of sections. In this example, the object detection unit 1a measures the gradient of the road 50a in the moving direction of the vehicle 30 as the change state of the road 50a. Specifically, the object detection unit 1a calculates the gradient of the road 50a based on the distance to the road 50a in the plurality of sections in the moving direction of the vehicle 30 and the projection angle of the laser light from the LD corresponding to each section (the angle with respect to the horizontal direction) among the plurality of sections determined that the road 50a is present as described above.

The region setting unit 1c sets a short distance detection region Rn and a long distance detection region Rf in the predetermined range Z as illustrated in FIG. 7B, FIG. 8B, and FIG. 9B based on the change state (gradient) of the road 50a measured by the object detection unit 1a. Specifically, the region setting unit 1c sets the short distance detection region Rn and the long distance detection region Rf in the predetermined unit Z in a unit of section according to the direction (up and down) and the size of the gradient of the road 50a calculated by the object detection unit 1a. The short distance detection region Rn is a detection region for detecting a target object 50 at the short distance shorter than a predetermined distance from the vehicle 30 (or from the target object detection device 100). The long distance detection region Rf is a detection region for detecting a target object 50 at the long distance equal to or longer than a predetermined distance from the vehicle 30.

For example, if the gradient of the road 50a is almost zero (gradient≈0), the region setting unit 1c sets a plurality of (in this example, six) sections that are positioned substantially in the middle of the predetermined range Z as the long distance detection region Rf as illustrated in FIG. 7B. In addition, the region setting unit 1c sets all the other sections positioned around the long distance detection region Rf as the short distance detection region Rn. The setting state in FIG. 7B is a reference position of the long distance detection region Rf and the short distance detection region Rn.

If the road 50a has a certain gradient (gradient≠0), the region setting unit 1c adjusts the position of the long distance detection region Rf and the short distance detection region Rn to the vertical direction (up-down direction) in a unit of section as illustrated in FIG. 8B and FIG. 9B according to the direction and magnitude of the gradient.

Specifically, if the road 50a has an upward gradient (gradient>0), the region setting unit 1c moves the long distance detection region Rf upward according to the magnitude of the gradient as illustrated in FIG. 8B. All the other sections positioned around the long distance detection region Rf are set as the short distance detection region Rn.

In addition, if the road 50a has a downward gradient (gradient<0), the region setting unit 1c moves the long distance detection region Rf downward according to the magnitude of the gradient as illustrated in FIG. 9B. All the other sections positioned around the long distance detection region Rf are set as the short distance detection region Rn.

At this time, the region setting unit 1c sets the long distance detection region Rf such that a forward portion 50s of the road 50a can be captured. That is, the section that is in the moving direction of the vehicle 30 and in which the road 50a is detected at the position farthest from the vehicle 30 is set as the forward portion 50s of the road 50a among the sections where the road 50a is detected to be present by the object detection unit 1a, and then, the long distance detection region Rf is set so as to include that section. For example, in FIG. 7B, since the sections in the columns D and E are positioned in the moving direction of the vehicle 30, the sections D4 and E5 among those sections correspond to the forward portion 50s of the road 50a, the section D4 and the section E5, and a plurality of sections D5, section D6, section E4, and section E6 in the vicinity thereof are set as the long distance detection region Rf.

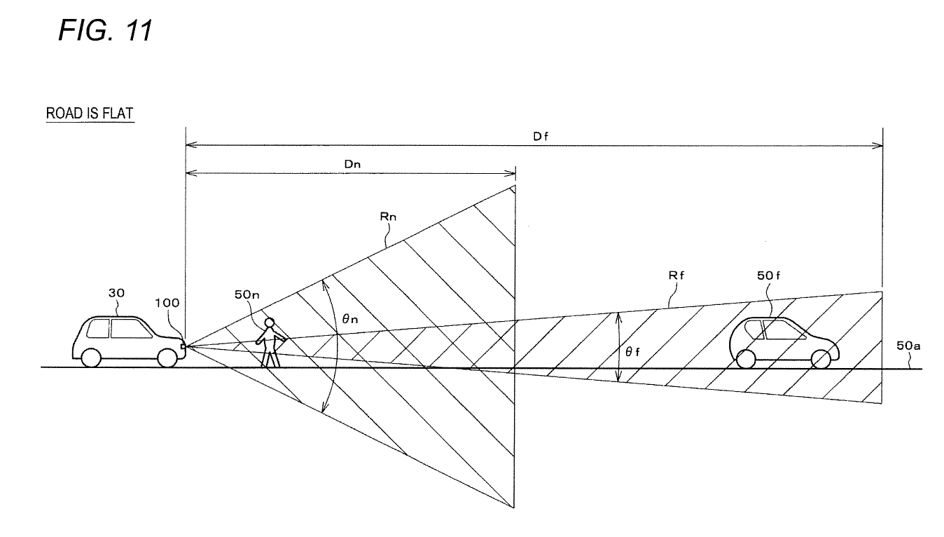

The control unit 1 in FIG. 5 controls the light emitting operation of the LD corresponding to each section in the predetermined range Z, the light receiving operation of the PD corresponding to each section, or the signal processing operation by the light receiving module 7 for the light reception signal output from the PD according to the rotation angle of the mirror 4a based on the result of setting performed by the region setting unit 1c. In this way, as illustrated in FIG. 11 to FIG. 13, the control unit 1 forms the short distance detection region Rn and the long distance detection region Rf in the predetermined range Z and adjusts the positions of both regions Rn and Rf.

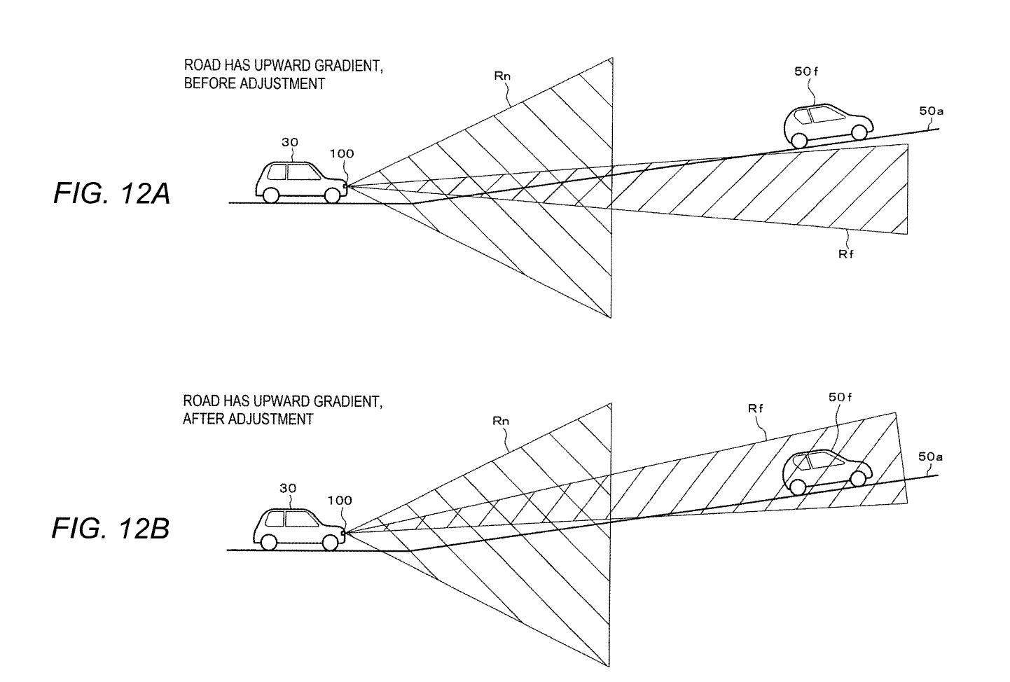

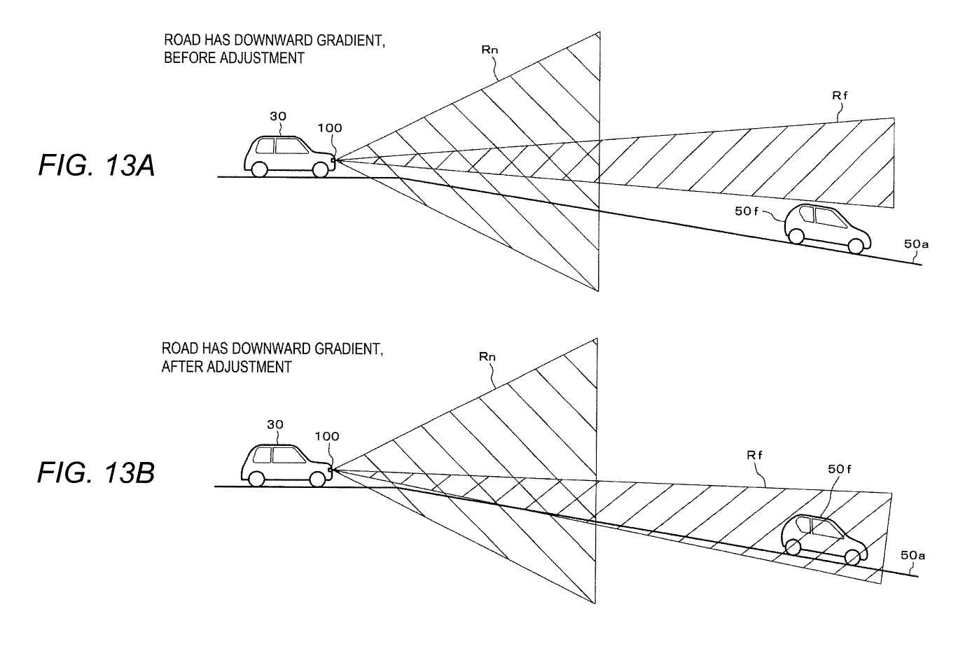

FIG. 11 to FIG. 13B are diagrams illustrating examples of the detection regions Rn and Rf set by the target object detection device 100. Specifically, FIG. 11 illustrates a case where the road 50a is flat, FIG. 12 illustrates a case where the road 50a has an upward gradient, and FIG. 13 illustrates a case where the road 50a has a downward gradient. In addition, in FIG. 11 to FIG. 13B, the detection regions Rn and Rf are illustrated as a state seen from the side of the vehicle 30.

For example, as illustrated in FIG. 11, the control unit 1 forms a fan-shaped short distance detection region Rn at a short distance shorter than a predetermined distance Dn from the vehicle 30, and forms a fan-shaped long distance detection region Rf so as to reach a long distance equal to or longer than the predetermined distance Dn penetrating the short distance detection region Rn. The predetermined distance Dn is equivalent to the projection distance of the laser light in the short distance detection region Rn. In the short distance detection region Rn, the spread angle θn of laser light is large such that almost all the target objects 50n such as a person being present at the short distance can be captured. In the long distance detection region Rf, the projection distance Df of the laser light is long such that the target object 50f such as the preceding vehicle or the oncoming vehicle being present at a long distance can be captured and the distance to the target object 50f can be measured with high accuracy.

Comparing the regions Rn and Rf, the spread angle θf of the laser light in the long distance detection region Rf is smaller than the spread angle θn of the laser light in the short distance detection region Rn. In addition, the projection distance Df of the laser light in the long distance detection region Rf is longer than the projection distance Dn of the laser light in the short distance detection region Rn. Furthermore, a detection sensitivity of the target object 50 in the long distance detection region Rf is higher than the detection sensitivity of the target object 50 in the short distance detection region Rn. The detection sensitivity is determined by a light emission frequency and a light emission power of the light pulse emitted from the projector module 2, and a light receiving sensitivity by the light receiving module 7, and the like.

In FIG. 12 and FIG. 13, the detection regions Rn and Rf are also formed in the same manner as described above. In FIG. 12A to FIG. 13B, for the sake of convenience in illustration, the illustration of distances Dn and Df and the angles θn and θf are omitted.

In addition, although not illustrated, the detection regions Rn and Rf are also formed in the horizontal direction (the direction perpendicular to the sheet in FIG. 11 to FIG. 13B) in the same manner as described above. That is, the short distance detection region Rn having a wide field of view in the vertical direction and the horizontal direction is formed in front of the vehicle 30 by the target object detection device 100, and the long distance detection region Rf having a narrow field of view but having the longer measurement distance and the higher detection sensitivity than that of the short distance detection region Rn, is formed.

In addition, if the road 50a on which the vehicle 30 is traveling is flat, as illustrated in FIG. 11, the long distance detection region Rf is formed so as to penetrate almost the center of the short distance detection region Rn. If the upward gradient occurs on the road 50a, the long distance detection region Rf changes as illustrated in FIG. 12A to FIG. 12B, the position of the long distance detection region Rf is adjusted so as to be moved upward. In addition, if the downward gradient occurs on the road 50a, the long distance detection region Rf changes as illustrated in FIG. 13A to FIG. 13B, the position of the long distance detection region Rf is adjusted so as to be moved downward.

The control unit 1 adjusts the projection distances Dn and Df and the projection amount of the laser light and adjusts the reception frequency and the light reception amount of each PD₁ to PD₃₂ by controlling the light emission power and the light emission frequency of LD₁ to LD₈ (FIG. 4 and FIG. 6) corresponding to each section in predetermined range Z according to the rotation angle of mirror 4a. Furthermore, the output frequency and output level of the light reception signal are adjusted by controlling the signaling processing frequency for processing the light reception signals output from each of the PD₁ to PD₃₂ by the TIA, MUX, VGA and ADC 8 of the light receiving module 7 or by controlling the amplification gain of the light reception signal by the VGA.

For example, the control unit 1 increases the projection distance Df of the laser light in the long distance detection region Rf and increases the projection amount by increasing the light emission power of the LD corresponding to the section of the long distance detection region Rf or by increasing the light emission frequency of the LDs (LD₃ and LD₄ in FIG. 6, for example). In addition, the reflection light amount and the light reception amount in the long distance detection region Rf are increased by increasing the reception frequency of the PD corresponding to the section in the long distance detection region Rf (for example, PD₉ to PD₁₆ in FIG. 6). Furthermore, the output frequency and the output level of the light reception signal based on the reflection light in detection region Rf are increased by increasing the signal processing frequency for the light reception signal from the PD corresponding to the section in the long distance detection region Rf performed by the by the light receiving module 7 and the ADC 8, and by increasing the amplification gain performed by the VGA. As a result, in the long distance detection region Rf, the light receiving sensitivity of the reflection light is increased and the detection sensitivity of the target object 50 is increased.

Conversely, the control unit 1 decreases the projection distance Dn of the laser light in the short distance detection region Rn and decreases the projection amount by suppressing the light emission power of the LD corresponding to the section in the short distance detection region Rn to be low, or by suppressing the emission frequency of the LD to be low (for example, LD₁, LD₂, LD₅ to LD₈ in FIG. 6). In addition, the reflection light amount and the light reception amount in the short distance detection region Rn is decreased by suppressing the light reception frequency of the PD corresponding to the section in the short distance detection region Rn to be low (for example, PD₁ to PD₈ and PD₁₇ to PD₃₂ in FIG. 6). Furthermore, the output frequency and the output level of the light reception signal based on the reflection light in the short distance detection region Rn are decreased by suppressing the signal processing frequency for the light reception signal from the PD corresponding to the section in the short distance detection region Rn by the light receiving module 7 and the ADC 8 to be low, or by suppressing the amplification gain by VGA to be low. As a result, in the short distance detection region Rn, the light receiving sensitivity of the reflection light is decreased and the detection sensitivity of the target object 50 is decreased, but the power consumption can be reduced.

In addition, since the number of times the LD and the PD can operate during one rotation of the mirror 4a is limited, the spread angle of the short distance detection region Rn and the field of view can be increased by increasing the number of sections to be set in the short distance detection region Rn as much as the operation frequency of LD and PD for each section in the short distance detection region Rn is suppressed to be low. In FIG. 7A to FIG. 9B, since many sections around the section set in the long distance detection region Rf are entirely set in the short distance detection region Rn, the spread angle and the field of view of the short distance detection region Rn are larger than the spread angle and the field of view of the long distance detection region Rf, respectively.

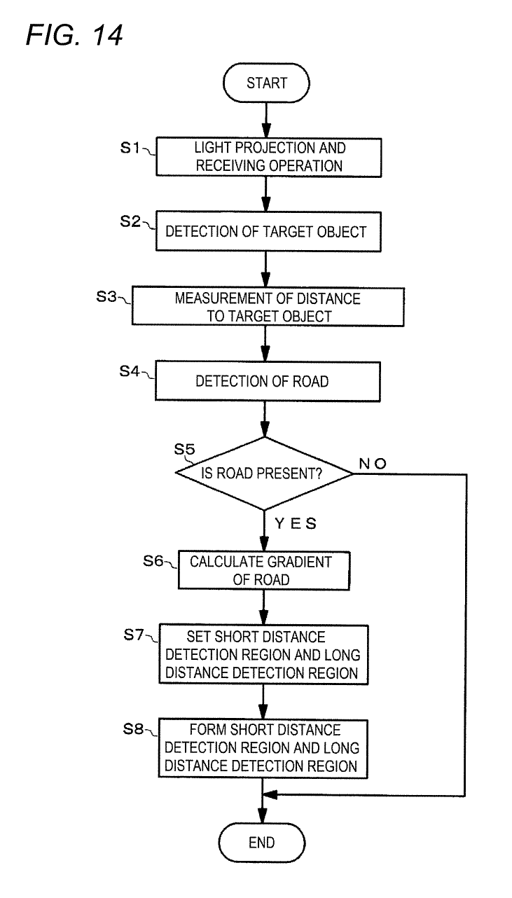

FIG. 14 is a flowchart illustrating the operation of the target object detection device 100. The operation is repeatedly performed by the control unit 1 while the target object detection device 100 is activated.

First, the control unit 1 controls the projector module 2, the light receiving module 7 and the rotary scanning unit 4, and performs the light projection and receiving operation to the predetermined range Z (STEP S1). That is, the control unit 1 rotates the mirror 4a of the rotary scanning unit 4 so as to cause each LD of the projector module 2 to sequentially emit the light and cause the laser light emitted from each LD to be reflected from the mirror 4a and projected to the predetermined range Z. In addition, the reflection light from the target object 50 in the predetermined range Z is reflected by the mirror 4a, and is sequentially received by each PD of the light receiving module 7, and then, the signal processing is performed on the light reception signal output from each PD by the TIA, MUX, VGA, and the ADC 8.

Then, the object detection unit 1a performs the processing for detection of the target object 50 (STEP S2). At this time, the object detection unit 1a detects the light receiving state of each PD and the presence or absence of the target object 50 based on the light emitting state of each LD and the light reception signal input from the light receiving module 7 via the ADC 8. In addition, the position, shape and type of the target object 50 are also detected based on the light emitting state of each LD, the light receiving state of each PD, the rotation angle of the mirror 4a.

Next, the distance measurement unit 1b performs the processing for measuring the distance to the target object 50 (STEP S3). At this time, based on the light reception signal input from the light receiving module 7 via the ADC 8, the distance measuring unit 1b measures the light receiving time of the reflection light from the target object 50, and calculates the time of flight from the time when the laser light is projected from the corresponding LD to the light receiving time of the reflection light. Then, the distance to the target object 50 in predetermined range Z is measured in a unit of section based on the time of flight, the light emitting state of each LD, the light receiving state of each PD, and the rotation angle of the mirror 4a, and the result of measurement is recorded in the storage unit 11.

Next, the object detection unit 1a performs the processing for the detection of the road 50a based on the result of measurement performed by the distance measurement unit 1b recorded in the storage unit 11 (STEP S4). If the road 50a is present in the moving direction of the vehicle 30 (YES in STEP S5), the object detection unit 1a calculates the gradient of the road 50a (STEP S6).

Next, the region setting unit 1c sets the short distance detection region Rn and the long distance detection region Rf in the predetermined range Z from which the target object 50 is detected, based on the gradient of the road 50a calculated by the object detection unit 1a (STEP S7). Then, the short distance detection region Rn and the long distance detection region Rf are formed in front of the vehicle 30 by the control unit 1 controlling the light emitting operation of the LD, the light receiving operation of the PD, and the signal processing operation of the light reception signal from the PD according to the rotation angle of the mirror 4a based on the result of setting by the region setting unit 1c (STEP S8). In the second and subsequent processing, in STEP S8, the control unit 1 adjusts the positions of short distance detection region Rn and the long distance detection region Rf based on the result of setting performed by the region setting unit 1c.

As in the embodiment described above, in the target object detection device 100, the object detection unit 1a detects the change state (gradient) of the road 50a in front of the vehicle 30 based on the result of measurement of the distance to the target object 50 performed by the distance measuring unit 1b. In addition, based on the change state of the road 50a, the region setting unit 1c sets the short distance detection region Rn and the long distance detection region Rf in the predetermined range Z from which the target object 50 is detected. The detection sensitivity of target object 50 is increased by the control unit 1 forming the short distance detection region Rn and the long distance detection region Rf in front of the vehicle 30, and increasing the projection distance of the laser light and decreasing the spread angle of the laser light in the long distance detection region Rf than those in the short distance detection region Rn. Therefore, the target object 50 at the short distance can be captured in the short distance detection region Rn where the spread angle of the laser light is large, and thus, it is possible to detect the target object 50 with high accuracy. In addition, the target object 50 at the long distance can be captured in the long distance detection region Rf where the projection distance of the laser light is long, and thus, it is possible to detect the target object 50 with high accuracy. Furthermore, even if there is a change in the road 50a in front of the vehicle 30, it is possible to accurately detect the target object 50 at the long distance in the long distance detection region Rf.

In addition, in the embodiment described above, the object detection unit 1a detects the gradient of the road 50a as the change state of the road 50a, and the region setting unit 1c adjusts the positions of the short distance detection region Rn and the long distance detection region Rf in the vertical direction according to the gradient. Therefore, even if the road 50a in front of the vehicle 30 is flat, and even if there is an upward gradient or a descending gradient on the road 50a, the long distance detection region Rf is set according to the road state, and thus, it is possible to detect the at the long distance and the target object 50 and to measure the distance to the target object 50 with high accuracy.

In addition, in the embodiment described above, the region setting unit 1c sets the long distance detection region Rf such that the forward portion 50s of the road 50a can be captured, and the short distance detection region Rn is set around the long distance detection region Rf. Therefore, even if the road 50a is not flat, the forward portion 50s of the road 50a can always be captured in the long distance detection region Rf, and thus, it is possible to detect the target object 50 in the forward portion 50s and to measure the distance to the target object 50 with higher accuracy. In addition, almost all the target objects 50 at the short distance can be captured by widening the short distance detection region Rn, it is possible to detect the target object 50 with high accuracy.

In addition, in the embodiment described above, the projector module 2 emits the measurement light and the light receiving module 7 receives the reflection light to and from a plurality of directions included in the predetermined range Z, and then, the distance measurement unit 1b measures the distance to the target object 50 in each direction. The distance to the road 50a in front of the vehicle 30 is determined from the measurement distance measured by the distance measurement unit 1b. Therefore, it is possible to reliably detect the change state of the road 50a in front of the vehicle 30.

In addition, in the embodiment described above, the distance measurement unit 1b measures the distance to the target object 50 in a unit of section which is a result of dividing the predetermined range Z seen from the target object detection device 100 side into a plurality of sections. Therefore, the object detection unit 1a can reliably detect the road 50a and the change state of the road 50a based on the distribution of the measurement distance of each section. Further, the region setting unit 1c can reliably set the short distance detection region Rn and the long distance detection region Rf in a unit of section in the predetermined range Z.

In addition, in the embodiment described above, since the measurement light and the reflection light are scanned by the rotary scanning unit 4, even without increasing the number of LDs provided in the projector module 2 or the number of PDs provided in the light receiving module 7, it is possible to emit the measurement light and receive the reflection light to and from the wide predetermined range Z in front of the vehicle 30. Then, it is possible to reliably measure the distance to the target object 50 in a unit of section which is the result of dividing the wide predetermined range Z into a plurality of sections based on the rotation angle of the mirror 4a of the rotary scanning unit 4, the light emitting state of each LD, the light receiving state of each PD, and the time of flight of from projection to reception of the light by the distance measurement unit 1b.

In addition, in the embodiment described above, a plurality of LDs and a plurality of PDs are arranged in the vertical direction, and each LD emits the light sequentially and each PD receives the light sequentially according to the rotation angle of the mirror 4a of the rotary scanning unit 4. Therefore, it is possible to expand the predetermined range Z in the vertical direction, from which the target object 50 is detected. In addition, since the measurement light and the reflection light are scanned in the horizontal direction by the rotary scanning unit 4, it is possible to widen the predetermined range Z in the horizontal direction. In addition, it is possible to reduce the cost by reducing the number of LDs and PDs to be installed. Furthermore, since an inexpensive rotary scanning unit 4 that scans the light only in the horizontal direction is used instead of an expensive rotary scanning unit that scans the light in both the horizontal direction and the vertical direction, it is possible to keep the low cost.

Furthermore, in the embodiment described above, the control unit 1 controls the light projection and receiving operation of the corresponding LD and PD by the rotation angle of the mirror 4a corresponding to the long distance detection region Rf, and controls the signal processing operation of the light reception signal from the corresponding PD. In this way, it is possible to reliably form the long distance detection region Rf having a long projection distance of laser light and a high detection sensitivity of the target object 50. In addition, the control unit 1 controls the light projection and receiving operation of the corresponding LD and PD by the rotation angle of the mirror 4a corresponding to the short distance detection region Rn, and controls the signal processing operation of the light reception signal from the corresponding PD. In this way, it is possible to reliably form the spread angle of the laser light and the short distance detection region Rn having a wide field of view.

In the invention, various embodiments other than the embodiment described above can be adopted. For example, in the embodiment described above, the gradient of the road 50a is detected as the change state of the road 50a in front of the vehicle 30, and the long distance detection region Rf and the short distance detection region Rn are set according to the gradient. However, the invention is not limited thereto. Besides this, for example, a curve (curves in the left-right direction) in the horizontal direction of the road 50a in front of the vehicle 30 may be detected, and the long distance detection region Rf and the short distance detection region Rn may be set according to the curve.

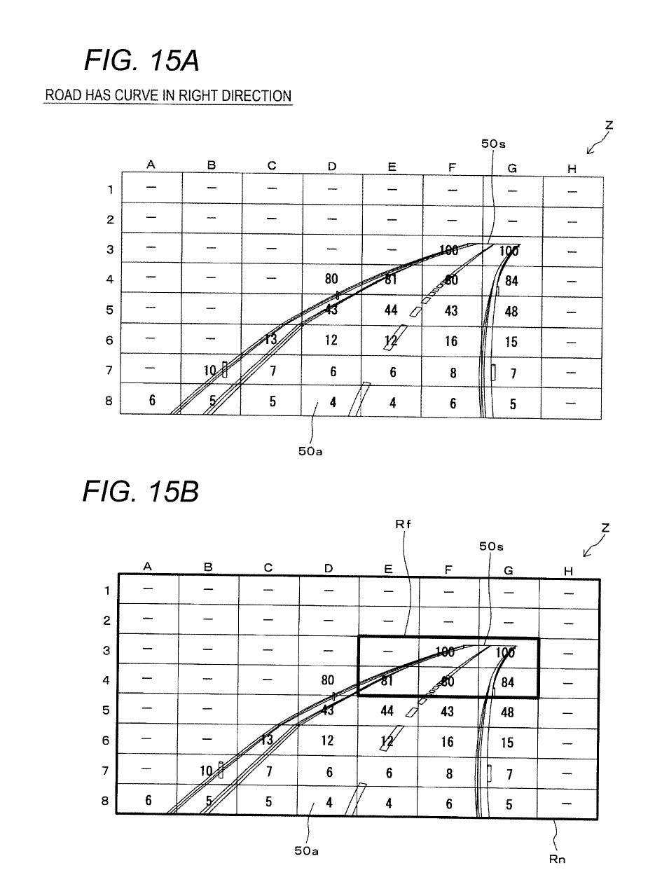

FIG. 15A and FIG. 15B are diagrams illustrating an example of the result of measuring the distance performed by the target object detection device 100 when there is a curve on the road 50a. When the distance measurement unit 1b measures the distance to the target object 50 in a unit of section of the predetermined range Z as illustrated in FIG. 15A, the object detection unit 1a determines the distance to the road 50a and the section where the road 50a is present based on the result of measuring the distance, the presence or absence of the curve of the road 50a and the direction (left and right) of the curve are detected based on the result of the determination. According to the result of detection of the road 50a and the result of measurement of the curve performed by the by the object detection unit 1a, the region setting unit 1c adjusts the position of the long distance detection region Rf to the left and right, and sets the short distance detection region Rn around the long distance detection region Rf. In FIG. 15A and FIG. 15B, since the forward portion 50s of the road 50a curves to the right with respect to the moving direction of the vehicle 30, as illustrated in FIG. 15B, the long distance detection region Rf is set so as to move to the right from the center of the predetermined range Z such that the forward portion 50s of the road 50a can be captured, and the short distance detection region Rn is set around the long distance detection region Rf.

The number of sections in the long distance detection region Rf and the short distance detection region Rn is not limited to the number described in the embodiments described above, and may be set as appropriate. In addition, the long distance detection region Rf and the short distance detection region Rn may be set not only as a plurality of sections arrayed in a rectangular shape, but also as a plurality of sections arranged in a stepwise manner, for example. Furthermore, not only setting all the sections in the predetermined range Z as the long distance detection region Rf or the short distance detection region Rn, for example, but also the predetermined range may be further widened and a part of the sections may be excluded from the long distance detection region and the short distance detection region.

In addition, in the embodiment described above, the distance to the target object 50 is measured by in a unit of section by diving the predetermined range Z from which the target object 50 is detected into a plurality of grid shaped sections, and the long distance detection region Rf and the short distance detection region Rn are set. However, the invention is not limited thereto. The predetermined range Z may be divided in a form other than a grid form, or the number of sections may be appropriately set.

In addition, in the embodiment described above, LDs are used as the light emitting element and PDs are used as the light receiving element. However, the invention is not limited thereto, and the light emitting element other than the LDs and the light receiving element other than PDs may be used. In addition, the number and arrangement of light emitting elements and light receiving elements can be set appropriately. In addition, if an avalanche photodiode (APD) or a single photon avalanche diode (SPAD) is used as the light receiving element, the detection sensitivity of the target object 50 may be changed by changing the multiplication factor of the APD and adjusting the light receiving sensitivity of reflection light.

In addition, in the embodiment described above, the laser light or the reflection light is scanned by the rotary scanning unit 4 having the plate shaped double-sided mirror 4a in the horizontal direction with respect to the predetermined range. However, the invention is not limited thereto. Besides this, a rotary scanning unit having a mirror whose reflective surface is three or more sides such as a polygon mirror may be used. In addition, a minute rotary scanning unit such as an electromagnetically driven laser scanning micro electro mechanical systems (MEMS) mirror may be used. In addition, the laser light from the LD is scanned to a predetermined range by a rotary scanning unit. However, the reflection light reflected from the target object in the predetermined range may be received by the light receiving element without going through the rotary scanning unit. In addition, a rotary scanning unit that scans the laser light or the reflection light in the horizontal direction or the vertical direction may be used. Furthermore, the light may be projected from a light emitting element to a predetermined range and the reflection light may be received by a light receiving element without providing the rotary scanning unit.

In addition, in the embodiment described above, the target object detection device 100 is installed in front of the vehicle 30 so as to emit and receive the light from and to the front of the vehicle 30. However, the invention is not limited thereto. Other than this, for example, the target object detection device 100 may be installed at the back portion of the vehicle 30 so as to emit and receive the light to the backward of the vehicle 30. In addition, the position where the target object detection device 100 is installed is not limited to the front or back portion of the vehicle 30, but may be the side portion of the vehicle 30.

Furthermore, the embodiment described above is applied to the target object detection device 100 configured with the laser radar mounted on a four-wheeled automobile. However, the invention can also be applied to a target object detection device to be mounted on other vehicles or on a moving body other than the vehicles. In this case, the target object detection device may be installed on any appropriate position of the moving body such that the light is emitted and received to and from a predetermined range including the moving direction of the moving body.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A target object detection device to be mounted on a moving body, the target object detection device comprising:
a projection unit that projects measurement light to a predetermined range including a moving direction of the moving body;
a light receiving unit that receives reflection light of the measurement light reflected from a target object in the predetermined range, and outputs a light reception signal corresponding to a light receiving state;
an object detection unit that detects the target object based on the light reception signal;
a distance measurement unit that measures a distance to the target object based on a time of flight from a time when the measurement light is projected by the projection unit to a time when the reflection light is received by the light receiving unit; and
a region setting unit that sets a short distance detection region for detecting the target object at a short distance shorter than a predetermined distance and a long distance detection region for detecting the target object at a long distance equal to or longer than the predetermined distance, in the predetermined range,
wherein the object detection unit detects a change state of a path through which the moving body passes based on a result of measurement performed by the distance measurement unit,
wherein the region setting unit sets the short distance detection region and the long distance detection region based on the change state of the path detected by the object detection unit, and
wherein a projection distance of the measurement light is longer, a spread angle of the measurement light is smaller, and a detection sensitivity of the target object is higher in the long distance detection region than those in the short distance detection region.

2. The target object detection device according to claim 1,
wherein the projection unit projects the measurement light in a plurality of directions in the predetermined range,
wherein the light receiving unit receives the reflection light from the plurality of directions and outputs the light reception signal based on the reflection light from each of the plurality of directions,
wherein the distance measurement unit measures the distance to the target object in each of the plurality of directions, and
wherein the object detection unit determines a distance to the path based on the distance to the target object in each of the plurality of directions measured by the distance measurement unit, and detects the change state of the path based on the distance to the path.

3. The target object detection device according to claim 1,
wherein the distance measurement unit measures the distance to the target object in a unit of section which is a result of dividing the predetermined range seen from the target object detection device side into a plurality of sections,
wherein the object detection unit detects the path and the change state of the path based on a distribution of the measurement distance of each of the plurality of sections measured by the distance measurement unit, and
wherein the region setting unit sets the short distance detection region and the long distance detection region in the unit of section.

4. The target object detection device according to claim 3, further comprising:
a rotary scanning unit that comprises a mirror, and by rotating the mirror, causes the measurement light projected from the projection unit to be reflected from the mirror and be scanned to the predetermined range, or causes the reflection light from the target object to be reflected from the mirror and be guided to the light receiving unit; and
a rotation measurement unit that measures a rotation angle of the mirror,
wherein the light receiving unit comprises a plurality of light receiving elements that receive the reflection light from the plurality of directions and output the light reception signal corresponding to the light receiving state, and
wherein the distance measurement unit measures a distance to the target object in the unit of section based on the rotation angle of the mirror, a projection state of the projection unit, the light receiving state of each of the plurality of light receiving elements, and the time of flight.

5. The target object detection device according to claim 4,
wherein the plurality of light receiving elements are arranged in a vertical direction,
wherein the projection unit comprises a plurality of light emitting elements arranged in the vertical direction and sequentially emitting light according to the rotation angle of the mirror,
wherein the rotary scanning unit horizontally scans the measurement light and the reflection light, and
wherein the distance measurement unit measures the distance to the target object in the unit of section which is a result of dividing the predetermined range into the plurality of sections having a grid shape, based on the rotation angle of the mirror, a light emitting state of each of the plurality of light emitting elements, the light receiving state of each of the plurality of light receiving elements, and the time of flight.

6. The target object detection device according to claim 5, further comprising:
a control unit that controls operations of the projection unit, the light receiving unit, and the rotary scanning unit,
wherein the control unit forms the short distance detection region and the long distance detection region within the predetermined range and adjusts positions of both of the short distance detection region and the long distance detection region by controlling a light emitting operation performed by the light emitting element corresponding to each of the plurality of sections, a light receiving operation performed by the light receiving element corresponding to each of the plurality of sections, or a signal processing operation performed by the light receiving unit for the light reception signal output from the light receiving element.

7. The target object detection device according to claim 1,
wherein the region setting unit sets the long distance detection region such that a forward portion of the path is configured to be captured, and sets the short distance detection region around the long distance detection region.

8. The target object detection device according to claim 1,
wherein the object detection unit detects a gradient of the path as the change state of the path, and
wherein the region setting unit adjusts positions of the short distance detection region and the long distance detection region in a vertical direction according to the gradient of the path detected by the object detection unit.
